(19) United States
(12) Patent Application Publication
(10) Pub. No.: US 2008/0075249 A1
(43) Pub. Date: Mar. 27, 2008

(54) Notification of failed prepaid call

(75) Inventors: Danny Zach, Kfar Neter (IL); Amnon Keiny, Tel Aviv (IL)

Correspondence Address: SUGHRUE MION, PLLC, 2100 PENNSYLVANIA AVENUE, N.W., SUITE 800, WASHINGTON, DC, 20037, US

(73) Assignee: COMVERSE LTD.

(21) Appl. No.: 11/517,359

(22) Filed: Sep. 8, 2006

(51) Int. Cl. H04M 15/00

(52) U.S. Cl. 379/114.17

(57) ABSTRACT

An apparatus for notification of a failed prepaid call, initiated in a telephony network by a calling party to a called party, including: a failed prepaid call data capturer, deployed in the telephony network, configured to capture data pertaining to the failed prepaid call from the network, and a notifier, associated with the failed prepaid call data capturer, configured to automatically notify the called party about the failed prepaid call, using the captured data.

### FIELD AND BACKGROUND OF THE INVENTION

The present invention relates to mobile telephony services and, more particularly, but not exclusively to an apparatus and a method for notification of a failed prepaid call.

Wireless communication technology has allowed individuals considerable freedom in how and when they communicate with each other. Analog signal-based cellular telephone technology, which allows people to travel freely while always having access to a telephone, has grown and developed into digital-based systems and hybrid telephone/multifunction devices so that a number of functions are now provided in a single integrated device.

In addition, wireless phones themselves have become much more sophisticated, incorporating the use of socalled smart cards, which allow for increased functionality in wireless devices. Such cards can store electronic money and user credit/debit information, within a developing industry standard for electronic data interchange (EDI) transactions.

There are two basic types of smart cards. An intelligent smart card contains a central processing unit (CPU) that actually has the ability to store information, secure the information, and make decisions using the information, as required by the card issuer's specific application needs. Because intelligent cards offer a read/write capability, new information can be added and processed. For example, monetary value can be added and decremented as a particular application may require.

The second type of card is often called a memory card. Memory cards may contain many forms of information, including a stored value which the user may spend in a pay phone, retail, vending or related transaction. Such cards come in both a no-contact form, in which the cards are read by readers when the cards are in the proximity of the reader, and cards adapted for electrical coupling to specific adapters, such as those which may be found in many newer cellular phone models.

Beyond merely producing a wireless device, the wireless service provider faces the challenge of ensuring the revenue stream from the constituents of the service provider.

There are a number of means of access to the service component of wireless technology.

Traditionally, when a client wants a cellular telephone, the client enters into a service contract with a cellular telephony provider, either with the provider directly or with a retailer distributing the services of the cellular telephony provider. A cellular phone purchased by the client from the retailer or from the cellular telephony provider is configured to work through the service provided by the cellular telephony provider.

Typically, the user uses the phone at will and simply pays a monthly fee which is computed by the service provider according to a variety of parameters, such as a fixed basic price and a price which varies according to the air time consumed by the user of the cellular phone. However, there are other service options as well.

One option to the traditional account maintenance option is the socalled pre-paid cellular service. For example, users who have dubious credit ratings, or corporations seeking to control the cost of a number of individual phones, pre-purchase cellular service from a particular provider for a particular phone. The access to the cellular service is typically cutoff once the pre-paid amount of the service is used up.

One exemplary pre-paid system currently in use is the Philips™ ISIS telephone, which allows the use of a prepaid calling card with a wireless telephony service. However, while this system allows for a pay-per-call service, once the calling cards are depleted, the customer has to go to a retail location and purchase new calling cards.

Prepaid subscribers have become a large part of mobile subscribers all over the globe. A fundamental feature of a prepaid calling service in a mobile telephony network is the ability to block call attempts when the calling subscriber is running out of credit. However, each call blocked for insufficient credit presents a potential loss of air time and revenues for the operator of the mobile telephony network.

Attempts at recovering the air time and revenue loss which an operator of a mobile telephony network may experience as a result of phone calls blocked for insufficient prepaid credit have been made.

For example, U.S. patent application Ser. No. 10/401,986, to McRaild, Christopher et al. entitled “Mobile invoked ‘call me’ back system for wireless subscribers with insufficient account balances”, filed on Mar. 31, 2003, discloses a mobile invoked call-me back system for wireless subscribers with insufficient account balances.

With the McRaild system, mobile subscribers who have insufficient and/or no funds in their prepaid account, may continue using their mobile service nonetheless by initiating a free (in a preferred embodiment) call-me SMS (Short Message Service) messaging to another mobile subscriber (or land-line phone which are equally equipped with such SMS capabilities). The calling party then is expected to return the call.

However, with the McRaild system, the calling party has to take an active role in the effort to recover the lost call, by intiating the call-me SMS messaging. Furthermore, the call-me SMS messaging service may be abused by users.

There is thus a widely recognized need for, and it would be highly advantageous to have, a system for notification of failed prepaid call, devoid of the above limitations and shortcomings.

### SUMMARY OF THE INVENTION

According to one exemplary embodiment of the present invention there is provided an apparatus for notification of a failed prepaid call, initiated in a telephony network by a calling party to a called party. The apparatus comprises a failed prepaid call data capturer, deployed in the telephony network, configured to capture data pertaining to the failed prepaid call from the telephony network. The apparatus further comprises a notifier, associated with the prepaid call data capturer, and configured to automatically notify the called party about the failed prepaid call, using the captured data.

According to a second exemplary embodiment of the present invention, there is provided a method for notification of a failed prepaid call, initiated in a telephony network by a calling party to a called party. The method comprises: capturing data pertaining to the failed prepaid call from the telephony network, and automatically notifying the called party about the failed prepaid call, using the captured data.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or operations manually, automatically, or a combination thereof. Moreover, according to actual instrumentation and equipment of preferred embodiments of the method and system of the present invention, several selected operations could be implemented by hardware or by software on any operating system of any firmware or a combination thereof. For example, as hardware, selected operations of the invention could be implemented as a chip or a circuit. As software, selected operations of the invention could be implemented as a plurality of software instructions being executed by a computer using any suitable operating system. In any case, selected operations of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of exemplary embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

A brief description of each of the drawings is set forth below:

FIG. 1 is a first block diagram illustrating an apparatus for notification of a failed prepaid call, initiated in a telephony network by a calling party to a called party, according to an exemplary embodiment.

FIG. 2 is a block diagram illustrating a system for notification of a failed prepaid call, initiated in a telephony network by a calling party to a called party, according to an exemplary embodiment.

FIG. 3 is a flowchart illustrating a method for notification of a failed prepaid call, initiated in a telephony network by a calling party to a called party, according to an exemplary embodiment.

FIG. 4 is a block diagram illustrating a scenario for implementing a method for notification of a failed prepaid call, initiated in a telephony network by a calling party to a called party, utilizing a system according to an exemplary embodiment.

### DESCRIPTION OF THE PREFERRED EMBODIMENTS

The present embodiments comprise an apparatus and a method for notification of a failed prepaid call, initiated in a telephony network by a calling party to a called party.

Currently, a user of a telephony network, such as a cellular telephony network, may subscribe to a prepaid calling service in the telephony network. The subscribed user pre-pays for call credit, assigned to the user by the telephony network operator.

According to exemplary embodiments of the present invention, when a call initiated by the subscribed user is blocked due to insufficient prepaid call credit left for the subscribed user, the air time and revenue lost as a result of the blocking of the call may be recovered.

According to the exemplary embodiments, when the prepaid call fails, the called party may be automatically notified of the failed attempt of the calling party, who is the prepaid calling service subscriber, to call the called party.

Once the called party receives the notification regarding the failed attempt to call him, the called party may initiate a call to the calling party of the prepaid call. Consequently, the revenues and air time potentially lost as result of the failure of the prepaid call may be recovered.

Optionally, the called party may also be automatically connected to the calling party in a callback call, provided that the called party agrees to be connected in the callback call (and to pay for the callback call).

Thus, according to the exemplary embodiments, the calling party does not have to take an active role in the effort to recover the lost prepaid call (for example—by initiating an SMS message). Furthermore, the exemplary embodiments may provide an apparatus and a method which may prove significantly less prone for abuse by users.

The principles and operation of an apparatus and a method according to the exemplary embodiments of the present invention may be better understood with reference to the drawings and accompanying description.

Before explaining at least one embodiment of the invention in detail, it is to be understood that the invention is not limited in its application to the details of construction and the arrangement of the components set forth in the following description or illustrated in the drawings.

The invention is capable of other embodiments or of being practiced or carried out in various ways. Also, it is to be understood that the phraseology and terminology employed herein is for the purpose of description and should not be regarded as limiting.

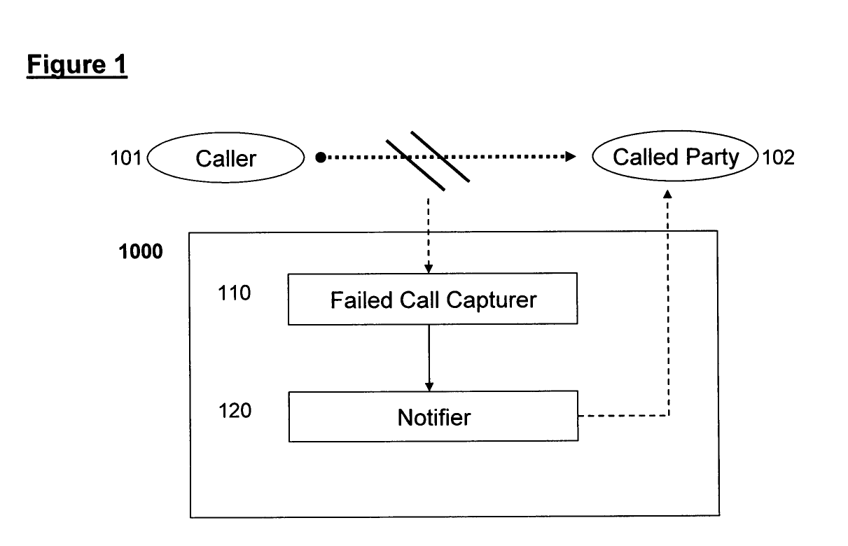

Reference is now made to FIG. 1, which is a block diagram illustrating an apparatus for notification of a failed prepaid call, initiated in a telephony network by a calling party to a called party, according to an exemplary embodiment.

Apparatus 1000 includes a failed prepaid call data capturer 110.

The failed prepaid call data capturer 110 is deployed in the telephony network, and configured to capture data pertaining to the failed prepaid call from the telephony network. The failed prepaid call is initiated by a calling party 101 to a called party 102 in the telephony network.

Optionally, the failed prepaid call data capturer 110 captures the data pertaining to the failed prepaid call from the telephony network, as the prepaid call fails, or immediately after the failure of the call.

Optionally, the failed prepaid call data capturer 110 uses a predefined capturing policy when capturing the data pertaining to the failed prepaid call. For example, the predefined capturing policy may define rules for recognizing a failed prepaid call, rules for distinguishing between relevant and non-relevant failed calls (the latter calls being ignored by the failed prepaid call capturer 110), etc.

The apparatus further includes a notifier 120, connected to the prepaid call data capturer 110.

The notifier 120 automatically notifies the called party 102 about the failed prepaid call, using the data captured by the failed prepaid call data capturer 110.

Optionally, the notifier 120 may notify the called party 102 about the failed prepaid call utilizing Short Message Service (SMS).

SMS is a service available on most digital mobile phones. SMS permits the sending of short messages between mobile phones, other handheld devices, and even landline phones which are preconfigured for receiving SMS messages.

Optionally, the notifier 120 may notify the called party 102 about the failed prepaid call utilizing Unstructured Supplementary Services Data (USSD).

USSD is a method of transmitting information or instructions over a GSM network (GSM—Global System for Mobile communication is European digital standard for mobile or cellular telephony). USSD has some similarities with SMS since both use the signaling path of a cellular GSM network.

However, unlike SMS, USSD is not a store and forward service and is session-oriented, such that when a user accesses a USSD service, a session is established and the radio connection stays open until the user, an application, or a time out releases it.

Optionally, the notifier 120 may notify the called party 102 about the failed prepaid call utilizing email, WAP (Wireless Application Protocol), MMS (Multimedia Message Service), or any other method for transmitting information over a cellular network.

Optionally, the notifier 120 automatically establishes a callback call connection between the called party 102 and the calling party 101 of the failed prepaid call. As known in the art, the called party 102 must first agree to accept the callback call before the callback connection is actually opened for both the called party 102 and the calling party 101, as the called party 102 may have to pay for the callback call.

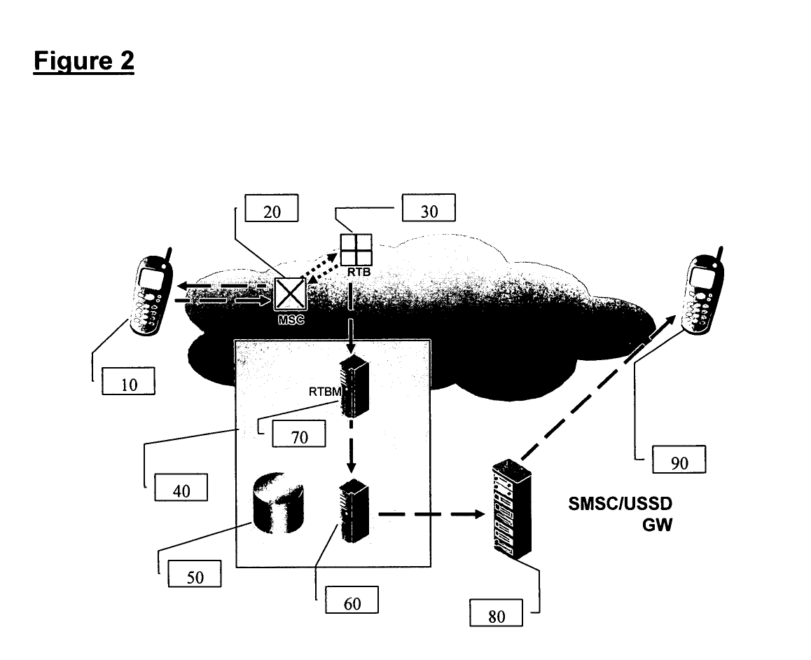

Reference is now made to FIG. 2, which is a block diagram illustrating a system for notification of a failed prepaid call, initiated in a telephony network by a calling party to a called party, according to an exemplary embodiment.

A system according to an exemplary embodiment is implemented as a part of a central infrastructure of a cellular telephony network. The cellular telephony network connects a handset 10 used by a calling party of a prepaid call and a handset 90 used by a called party of the prepaid call.

The cellular telephony network includes one or more Mobile Switching Center(s) (MSC) 20. A Mobile Switching Center (MSC) is a computer that places the calls, and takes and receives data from the subscriber(s) of the network or from a PSTN (Public switched Telephone Network).

The cellular telephony network further includes a Real Time Billing (RTB) system 30. The Real Time Billing (RTB) handles the financial aspects of cellular phone calls, including, but not limited to: billing prepaid calls, managing credit assigned to the calling party for prepaid calls, rejecting prepaid call attempts when the calling party runs out of credit, etc.

The cellular telephony network further includes a Short Message Service Center (SMSC) 80 which provides a Short Message Service (SMS), for routing SMS or other short messages between subscribers of the telephony network, as well as users of other telephony networks. As discussed above, the cellular telephony network may optionally include a Multi-Media Message Service (MMS) or other services for communicating to the called phone 90.

System 40, for notification of a failed prepaid call, includes a failed prepaid call capturer 70.

The failed prepaid call capturer 70 is implemented as a server mediating between the cellular network and the system 40. The failed prepaid call data capturer 70 captures data pertaining to a failed prepaid call, blocked by the RTB system 30, described hereinabove.

System 40 further includes a notifier 60 implemented as a Notification Delivery Unit (NDU) on a dedicated server. The notifier 60 is functionally associated with to the failed prepaid call capturer 70.

The notifier 60 automatically notifies the called party 90 about the failed prepaid call, using the data captured by the failed prepaid call data capturer 70.

The notifier 60 may notify the called party 90 about the failed prepaid call from the calling party 10, utilizing, for example, Short Message Service (SMS), utilizing Unstructured Supplementary Services Data (USSD), or using any other messaging service available in the telephony network.

Optionally, the notifier 60 automatically establishes a callback call connection between the called party 90 and the calling party 10 of the failed prepaid call. As known in the art, the called party 90 must first agree to accept the callback call before the callback connection is actually opened for both the called party 90 and the calling party 10, as the called party may have to pay for the callback call.

Optionally, system 40 further includes a database 50 for recording information pertaining to captured failed prepaid call, the notification of the called party of the failed prepaid call, the callback call connection established between the called party 90 and the calling party 10, etc.

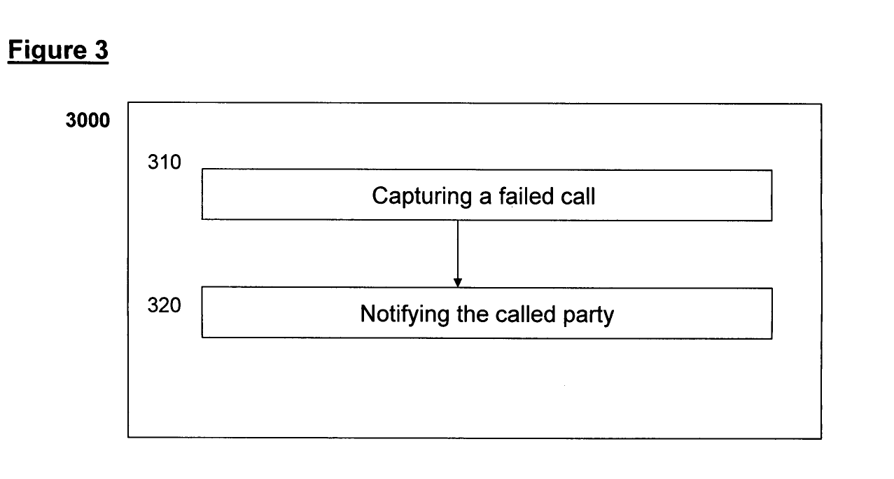

Reference is now made to FIG. 3, which is a flowchart illustrating a method for notification of a failed prepaid call, initiated in a telephony network by a calling party to a called party, according to an exemplary embodiment.

Method 3000 includes capturing 310 data pertaining to the failed prepaid call from the telephony network (such as a cellular telephony network). The capturing 310 may be carried out using a failed prepaid call capturer 110, as described in further detail hereinabove.

Next, the called party is automatically notified 320 of the failure of the prepaid call, using the data pertaining to the failed prepaid call captured 310 from the telephony network.

Optionally, the capturing 310 of the data pertaining to the failed prepaid call is carried out immediately as the prepaid call fails, or soon thereafter. For example, when the prepaid call is blocked due to the exhaustion of the credit assigned to the calling party for prepaid calls, as described in greater detail hereinabove.

Optionally, the capturing 310 of the filed prepaid call is carried out using a predefined capturing policy. The capturing policy may define, but is not limited to: rules for recognizing a failed prepaid call, rules for distinguishing between relevant and non-relevant failed calls (the latter calls being ignored during the capturing 310), etc.

Optionally, method 3000 further includes establishing a callback call connection between the called party 102 and the calling party 101 of the failed prepaid call. As known in the art and discussed hereinabove, the called party 102 has to agree to accept the callback call before the callback connection is actually opened for both the called party 102 and the calling party 101, as the called party 102 may have to pay for the callback call.

Optionally, the capturing of the failed prepaid call also includes monitoring of data traffic between one or more mobile switching center(s) and a billing system, in a cellular network, as described in further detail hereinabove.

Optionally, the capturing of the failed prepaid call also includes analyzing data generated by a real time billing system used for billing the calling party 101 for prepaid calling.

Optionally, the capturing of the failed prepaid call also includes analyzing Parlay event data generated in the telephony network.

Parlay is a family of application programming interfaces (APIs) defined by a telecomm industry consortium seeking to standardize a set of abstract high-level interfaces for use by third-party programmers. The set of abstract high-level interfaces is used by the third-party programmers in building applications that leverage the services and functionality exposed by telecommunication network elements.

Optionally, the capturing of the failed prepaid call also includes analyzing Open Scripting Architecture (OSA) event data generated in the computer infrastructure of the telephony network, as known in art.

Optionally, the capturing of the failed prepaid call also includes analyzing Intelligent Network Application Part (INAP) event data generated in the telephony network.

INAP is an intelligent network protocol used in European SS7 (a cellular protocol) cellular networks to query their databases for a variety of functions not related to call setup and tear down. INAP uses the ASN.1 standard for defining message content. ASN.1 is an international standard used for specification of data in communication protocols.

Optionally, the capturing of the failed prepaid call includes analyzing information generated by Customized Applications for Mobile networks Enhanced Logic (CAMEL). CAMEL is a set of GSM standards designed to work on a GSM core network. The standards allow an operator to define services over and above standard GSM services. The CAMEL architecture is based on the Intelligent Network (IN) standards, and uses the CAP (CAMEL Application Part) protocol. The CAP protocol is used for implementing enhancements specific to mobile domains an Intelligent Network (IN) based on the CAMEL architecture.

Optionally, the notification 310 of the called party is carried out utilizing Short Message Service (SMS).

SMS is a service available on most digital mobile phones that permits the sending of short messages between mobile phones, other handheld devices, and even landline phones, as explained hereinabove.

Optionally, the notification 310 of the called party is carried out utilizing call utilizing Unstructured Supplementary Services Data (USSD).

Optionally, the notification 320 of the called party is carried out using a message which is formatted according to a predefined policy. The predefined policy may relate to a variety of aspects, including but not limited to: the language of the message, a predefined message template, etc.

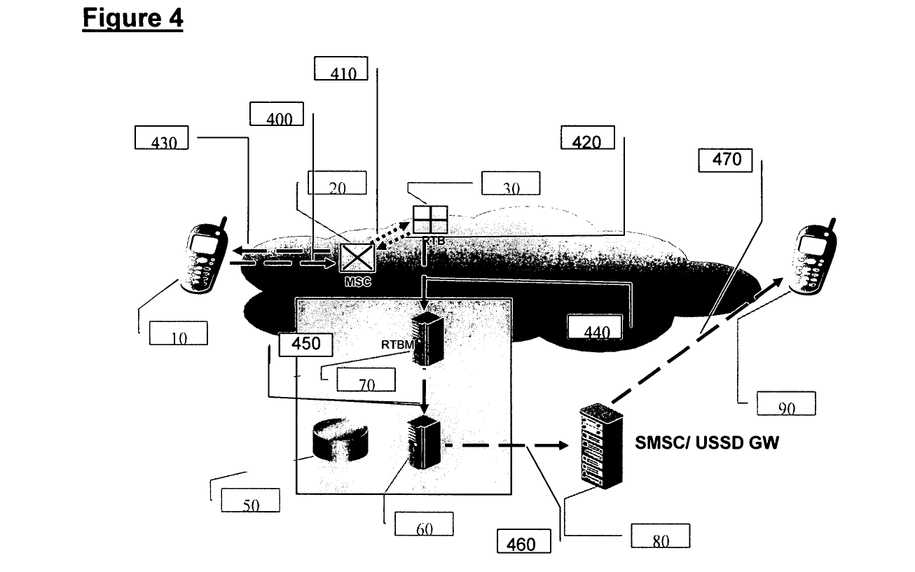

Reference is now made to FIG. 4, which is a block diagram illustrating a scenario implementing a method for notification of a failed prepaid call, initiated in a telephony network by a calling party to a called party, utilizing a system according to an exemplary embodiment.

In the exemplary scenario, a calling party 10 initiates a prepaid call 400 to a called party 90.

The Mobile Service Center (MSC) 20 checks 410 against the Real Time Billing (RTB) system if the calling party 10 has sufficient credit for the call.

When the calling party 10 runs out of prepaid call credit, the RTB system 30 rejects the call attempt due to the lack of credit 420 left for the calling party 10.

Next, the MSC (or an Intelligent Network's Network Peripheral Service, as known in the art) 20 informs 430 the calling party 10 that the call fails due to the lack of credit, and hangs up the call.

Then, the failed prepaid call capturer 70 captures 440 the details of the failed prepaid call. The details of the failed prepaid call may include, but are not limited to: The Caller Line Identification (CLI) of the calling party, The Mobile Station Integrated Services Digital Network (MSISDN) uniquely identifying the cellular handset used by the calling party, the time of call, pre-selected attributes pertaining to the calling party, pre-selected attributes pertaining to the called party, etc.

The call capturer 70 may be implemented using one or more of possible methods, including but not limited to: using one or more passive probe(s) for monitoring the data traffic between the Mobile Service center (MSC) 20 and the Real Time Billing (RTB) system 30, analyzing data generated by the Real Time Billing (RTB) 30, analyzing Open Scripting Architecture (OSA) events, analyzing Parlay events, and analyzing Intelligent Network Application Part (INAP) events, as described in further detail hereinabove.

Next, the call capturer 70 forwards 450 the captured details of the failed prepaid call to the notifier 60.

Finally, the notifier 60 formats a notification message according to a predefined policy including but not limited to rules relating to the language of the notification, a message template to be used for notification, etc.

The notifier 60 sends 460 the notification to the called party 90, via, for example, an SMSC/USSD gateway 80. The SMSC/USSD gateway 80 sends 470 the failed prepaid call notification to the called party 90.

It is expected that during the life of this patent many relevant devices and systems will be developed and the scope of the terms herein, particularly of the terms “Call”. “Cellular”, “Telephony”, “SMS”, “GSM”, “CAMEL”, “WAP”, “MMS”, “MSC”. “SMSC”, “USSD”, “OSA”, “INAP”, “GSM”, “MSISDN”, “CLI”, and “SS7”, is intended to include all such new technologies apriori.

Additional objects, advantages, and novel features of the present invention will become apparent to one ordinarily skilled in the art upon examination of the following examples, which are not intended to be limiting. Additionally, each of the various embodiments and aspects of the present invention as delineated hereinabove and as claimed in the claims section below finds experimental support in the following examples.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference.

In addition, citation or identification of any reference in this application shall not be construed as an admission that such reference is available as prior art to the present invention.

What is claimed is:

1. An apparatus for notification of a failed prepaid call, initiated in a telephony network by a calling party to a called party, comprising:
a) a failed prepaid call data capturer, deployed in the telephony network, and configured to capture data pertaining to the failed prepaid call from the telephony network; and
b) a notifier, associated with said prepaid call data capturer, configured to automatically notify the called party about the failed prepaid call, using the captured data.

2. The apparatus of claim 1, wherein said failed prepaid call data capturer is further configured to capture the data substantially simultaneously to the failure of the prepaid call.

3. The apparatus of claim 1, wherein said notifier is further configured to automatically connect a callback call from the called party to the calling party, said connecting of said callback call being conditioned upon acceptance of said callback call by the called party.

4. The apparatus of claim 1, wherein the telephony network is a mobile telephony network.

5. The apparatus of claim 1, wherein said failed prepaid call data capturer is further configured to use monitoring of data traffic between a mobile switching center (MSC) in the telephony network and a billing system deployed on the telephony network, for capturing the data.

6. The apparatus of claim 1, wherein said failed prepaid call data capturer is further configured to analyze data generated by a real time billing system, the real time billing system being used for billing the calling party for prepaid calls.

7. The apparatus of claim 1, wherein said failed prepaid call data capturer is further configured to analyze Parlay event data generated in the telephony network.

8. The apparatus of claim 1, wherein said failed prepaid call data capturer is further configured to analyze Open Scripting Architecture (OSA) event data generated in the telephony network.

9. The apparatus of claim 1, wherein said failed prepaid call data capturer is further configured to analyze Intelligent Network Application Part (INAP) event data generated in the telephony network.

10. The apparatus of claim 1, wherein said notifier is further configured to carry out said notifying using a short message service (SMS).

11. The apparatus of claim 1, wherein said notifier is further configured to carry out said notifying using a multi-media message service (MMS).

12. The apparatus of claim 1, wherein said notifier is further configured to carry out said notifying using Unstructured Supplementary Services Data (USSD).

13. The apparatus of claim 1, wherein said notifier is further configured to carry out said notifying using a message formatted according to a predefined policy.

14. The apparatus of claim 1, wherein said failed prepaid call capturer is further configured to use a predefined capturing policy for said capturing.

15. A method for notification of a failed prepaid call, initiated in a telephony network by a calling party to a called party, comprising:
a) capturing data pertaining to the failed prepaid call from the telephony network; and
b) automatically notifying the called party about the failed prepaid call, using the captured data.

16. The method of claim 15, wherein said capturing is carried out substantially simultaneously to the failure of the prepaid call.

17. The method of claim 15, further comprising automatically connecting a callback call from the called party to the calling party, said connecting of said callback call being conditioned upon acceptance of said callback call by the called party.

18. The method of claim 15, wherein the telephony network is a mobile telephony network.

19. The method of claim 15, wherein said capturing further comprises monitoring traffic between a mobile switching center (MSC) in the telephony network and a billing system deployed on the telephony network.

20. The method of claim 15, wherein said capturing further comprises analyzing data generated by a real time billing system, said real time billing system being used for billing the calling party for prepaid calling.

21. The method of claim 15, wherein said capturing further comprises analyzing Parlay event data generated in the telephony network.

22. The method of claim 15, wherein said capturing further comprises analyzing Open Scripting Architecture (OSA) event data generated in the telephony network.

23. The method of claim 15, wherein said capturing further comprises analyzing Intelligent Network Application Part (INAP) event data generated in the telephony network.

24. The method of claim 15, wherein said notifying is carried out using a short message service (SMS).

25. The method of claim 15, wherein said notifying is carried out using Unstructured Supplementary Services Data (USSD).

26. The method of claim 15, wherein said notifying is carried out using a message being formatted according to a predefined policy.

27. The method of claim 15, wherein said capturing is carried out according to a predefined capturing policy.

28. The method of claim 15, wherein said notifying is carried out using a multi-media message service (MMS).
